(19) United States
(12) Patent Application Publication
(10) Pub. No.: US 2005/0237164 A1
(43) Pub. Date: Oct. 27, 2005

(54) Monitors and methods of use thereof

(76) Inventors: Mark Andrew Finkelstein, Laguna Niguel, CA (US); David Paul Finkelstein, Sunnyvale, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/818,762

(22) Filed: Apr. 6, 2004

(51) Int. Cl. G08B 1/00

(52) U.S. Cl. 340/309.16; 340/527

(57) ABSTRACT

A monitor having a snooze feature that temporarily prevents the receiving unit from emanating sound and/or video is provided. The length of the disruption may be preselected by an individual at or near the receiving unit. The disruption may be overridden in the event that certain circumstances occur.

### BACKGROUND OF THE INVENTION

1. Field of the Invention

The present invention relates to an apparatus and method for monitoring a remote location. Specifically, the present application discloses a monitor, such as a baby monitor, which includes a snooze feature.

2. Background of the Invention

It is often advantageous for an individual to monitor a remote location. In one example, parents often prefer that a baby sleep in a nursery; however, it is often not practical for the parent or other care provider to stay in the nursery with the baby while he or she is sleeping. In order to assist in monitoring the baby, various baby monitors have been developed, which allow a parent or care provider to listen to and/or watch a baby in a remote location. Such monitoring is important in order to properly care for the baby. For example, if a baby starts to cry, he or she may need nourishment or a clean change of clothing.

Prior art monitors typically include a transmitter unit located adjacent a baby or patient, and a receiver unit located adjacent the parents or caregivers. When the baby or patient makes noise, the sounds are transmitted from the transmitting unit to the receiving unit located adjacent the parent or care provider (often in another room). Unfortunately, such monitors have substantial disadvantages which have not heretofore been addressed. For example, many parents or care providers place the receiving unit of the monitor in their bedroom while they are sleeping. If the baby makes noise in the middle of the night, the sounds made by the baby are transmitted to the room of the parent or care provider. This may keep the parent or care provider awake for far longer than is necessary, thus adversely affecting the sleep pattern of the parent or care provider for long periods of time during the night. Such interrupted sleep can lead to severe emotional trauma and health problems for the parent or care provider.

Additionally, many pediatricians and doctors that specialize in caring for infants recommend babies be permitted to cry for a certain amount of time prior to being attended to. This period of time generally increases as a baby grows older and larger. This is because babies often wake up and cry or whine for short periods and then fall asleep on their own. By periodically extending the length of time that the baby is allowed to cry before visiting the baby, babies often learn to fall asleep on their own and eventually, learn to sleep through the night. When a parent is sleeping, it can be very difficult to provide the baby with the time necessary to fall asleep on his or her own, without risking having the baby cry for too long a period, which is generally regarded as potentially harmful to the baby's psyche.

A parent awoken by sounds heard through the receiving unit of the monitor may either stay awake throughout a lengthy period of time waiting to see if the baby falls asleep, or may turn off the receiving unit of the monitor for a certain period of time and then turn the receiving unit back on to see if the baby is still awake or has fallen asleep. With regard to the former option, it is often disruptive to the parent and/or his or her spouse or significant other to listen to the baby throughout a period of time while the baby may be crying or making other noises, thus disrupting the night's sleep for all of those within hearing distance of the receiving unit. If the latter approach is adopted, the parent must struggle to stay awake to remember to turn the monitor back on after the predetermined amount of time has passed. This is often difficult and could result in the parent falling asleep prior to turning the receiving unit on, resulting in the baby remaining in a distressed state for a long period of time. Thus, there is a need for an improved monitor which overcomes the significant disadvantages of the monitors found in the prior art.

### SUMMARY OF THE INVENTION

A monitor, which can be used to listen to sounds and/or view video transmitted from a remote location, is augmented to include a snooze function. The user of the monitor can specify a period of time for which the receiving unit should cease to receive and/or broadcast sounds or video (the snooze duration). By activating the snooze function, the monitoring of the remote location will temporarily cease for the period of the snooze duration. This action is referred to below as disruption between the transmitting and receiving units of the monitor, but the implementation may rely on interrupting power to the transmitting or receiving unit, disabling the speaker of the receiving unit, disabling the transmitter of the transmitting unit, or other action that causes the speaker of the receiving unit to become quiet.

According to one embodiment, a snooze apparatus for temporarily silencing a receiving unit of a monitor system is provided. The apparatus comprises a receiving unit of a monitor system and a snooze apparatus connected to the receiving unit. The snooze apparatus comprises a timer, an actuator and an interrupt circuit configured to interrupt a signal produced by the receiving unit when the actuator is engaged. The signal is preferably interrupted for no longer than a duration selected on the timer.

According to another embodiment, a method of temporarily silencing a baby monitoring system is provided. The method comprises placing a transmitter unit of an audio monitor adjacent a person to be monitored, placing a receiver unit of an audio monitor adjacent a caregiver, and connecting the receiver unit to a snooze apparatus. A timer of the snooze apparatus is then set to a pre-selected interval. Upon hearing a sound through the monitor, a caregiver can depress a snooze button of the snooze apparatus. According to the present embodiment, depressing the snooze button starts the timer and silences the receiver unit. Subsequently, the audio signal is re-established, preferably after the duration selected on the timer expires.

### BRIEF DESCRIPTION OF THE DRAWINGS

The preferred embodiments of the improved monitor and methods of use thereof, illustrating its features, will now be discussed in more detail. These elements depict a novel and nonobvious monitor shown in the accompanying drawings, which are for illustrative purposes only. These drawings include the following figures, in which like numerals indicate like parts:

FIG. 1 is a top plan view of a snooze apparatus that can be used with a prior art monitor;

FIG. 2 is a front elevational view of the apparatus of FIG. 1;

FIG. 3 is a left side elevational view of the apparatus of FIG. 1;

FIG. 4 is a front elevational view of another embodiment of the monitor apparatus;

FIG. 5 is a right side elevational view of the apparatus of FIG. 4; and

FIG. 6 is a top plan view of the apparatus of FIG. 4.

### DETAILED DESCRIPTION OF THE PREFERRED EMBODIMENTS

Many settings exist in which an individual would like to monitor a remote location. For example, a parent or other care provider, such as a babysitter, may want to monitor the sounds a baby makes while the baby is sleeping. In addition, many individuals provide care for elderly or ill individuals. It is advantageous for the care provider in such instances to be able to listen to the elderly or ill person in the event that that person has a request, instead of having to physically visit the person multiple times to assure that their needs are met. Moreover, an individual at a remote location may want to simply assure that proper conduct is occurring at a remote location. For example, a parent may want to monitor a child's room to assure that the child is properly studying, as opposed to playing with toys or speaking to friends on the telephone.

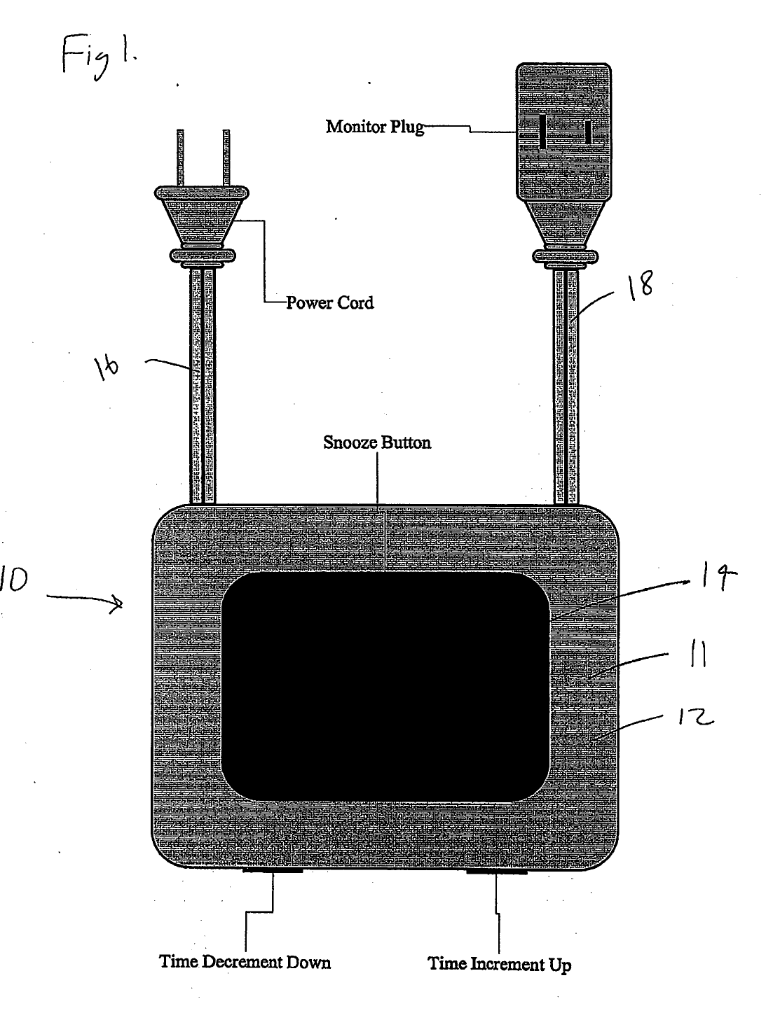

As described above, prior monitors that constantly transmit sounds from a remote location to a receiver have several disadvantages. Referring to FIG. 1, the present invention provides a unique solution to many of the disadvantages of the prior art monitors. A snooze apparatus 10 is provided having a housing 11. The housing 11 preferably includes a top surface 12 with a snooze button 14 that may be depressed by the user of the receiving unit (not shown) of the monitor. The housing 11 may be of any shape or configuration and may be constructed of a variety of materials. Preferably, the housing 11 is generally rectangular in shape and manufactured from a durable plastic; although other materials such as wood, metals and polymers may be used as will be understood by those of skill in the art. The snooze apparatus 10 preferably has a snooze button 14 on a top, generally horizontal surface 12 of the snooze apparatus 10. The snooze button 14 is preferably in a location that is easy for the user of the apparatus 10 to push the button 14. In the event that an individual is awoken from his or her sleep as described in more detail below and decides to depress the button 14, it is easy for the individual to reach the button 14 if it is located on the top surface 12 of the snooze apparatus 10. In addition, as shown in FIG. 1, the snooze button 14 is preferably large in surface area, which makes it easy to depress by a user.

The snooze apparatus 10 preferably includes a power cord 16 that may be plugged into an outlet (not shown). Alternatively, the snooze apparatus 10 may be powered by batteries (not shown) or other sources of power such as solar energy and the like.

The snooze apparatus 10 in the embodiment shown in FIG. 1 is adapted for use with a standard monitor which an individual may own. In such prior art monitors, the transmitting unit is plugged into an outlet at or near the area to be monitored. The receiving unit is plugged into an outlet at a remote location where the individual conducting the monitoring is located. With such monitors, the plug of the receiving unit may be plugged into the outlet 18 of the snooze apparatus 10 shown in FIG. 1. Thus, the receiving unit of the monitor is electrically connected with the snooze apparatus 10 via monitor plug 18, and the snooze apparatus 10 is connected to a power source, such as the electrical system of a home via power cord 16. Alternatively, the snooze apparatus can be configured to receive DC power (typically about 9 Volts) from a transformer or a battery. In still further configurations, the outlet 18 of the snooze apparatus 10 can be configured to provide DC power (typically about 9 volts) to the monitor receiving unit.

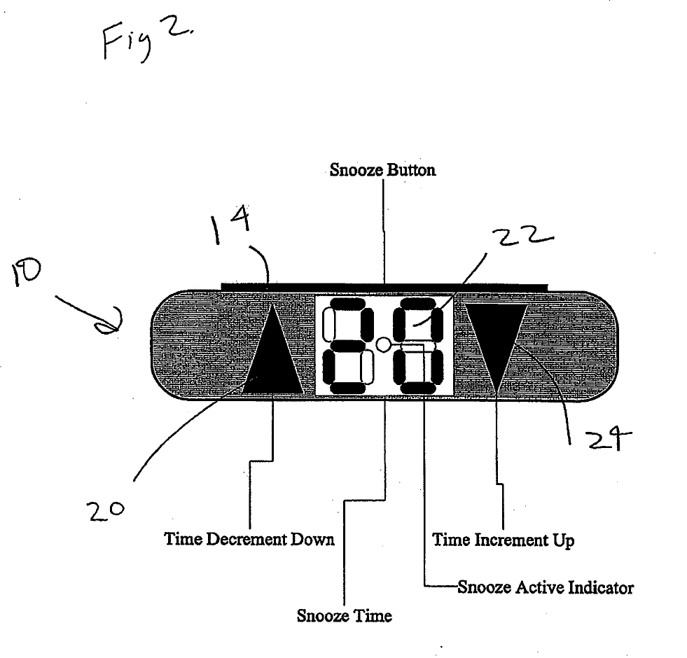

Referring to FIG. 2, the snooze apparatus 10 preferably includes a time display 22 and control buttons 20, 24 to control the amount of time shown on the time display 22. Although the time display 22 of the illustrated embodiments is shown to be a digital display, it could alternatively comprise an analog display in the form of a clock face, a dial or other suitable arrangement.

In use, once the parent or caregiver hears sounds from the remote location through the monitor, such as the baby nursery, he or she may listen to the sounds and determine whether immediate care is necessary. If immediate care is not necessary, instead of staying awake for continual listening, the parent may depress the snooze button 14. Once the snooze button 14 is depressed, the monitoring unit will become quiet. In this embodiment, the snooze apparatus 10 causes the monitor to become quiet by temporarily interrupting a supply of power to the receiving unit.

The length of the interruption may be pre-selected by the user using the time increment buttons 20, 24. That is, the user depresses the time increment buttons 20, 24 so that the desired amount of time of interruption of the receiving unit is displayed on the time display 22. As illustrated in FIG. 2, if the snooze button 14 is depressed, the disruption between the transmitting and receiving units of the monitor will be twenty minutes. At the end of the twenty minutes, the transmitting and receiving units are placed back in communication, such as by restoring power to the receiver unit as in the present example. At that point, the individual will either hear silence in which case no sound is being generated at the remote location at or near the transmitting unit. Or if the baby or patient is still making sounds, the individual will hear that and may then decide to visit the baby to provide care or may decide to depress the snooze button 14 again.

In alternative embodiments, the snooze apparatus can employ other mechanisms to interrupt an audio signal produced by the receiving unit. For example, the speaker on the monitor can be isolated such as by opening a circuit supplying a signal to the speaker. Alternatively, the volume of the receiver speaker can be reduced to a substantially lower volume such that any transmitted sounds are only slightly audible if audible at all. Alternatively still, the communication between the transmitting unit and the receiving unit can be interrupted, or the ability of the transmitting unit to receive sounds can be curtailed such as by opening a circuit carrying a signal from a microphone or audio transducer in the transmitting unit.

Preferably, the time increment buttons 20, 24 each affect the time display 22 in opposite manners. For example, by pushing the button 20, the amount of time of disruption between the transmitting and receiving units would be increased. Each time the button 20 is depressed, the time display may increase by one minute, five minutes, or any other time increment. If the button 24 is depressed, the time set forth on the time display 22 can be decreased in a similar fashion. Thus, the individual can select the exact time increment of non-communication between the transmitting and receiving units. Although the buttons 20, 24 are shaped as arrows in FIG. 2 to remind the user which button increases the amount of time on the time display 22 and which button decreases time on the time display 22, the buttons may be of any shape or configuration and can be located anywhere on the housing 11 of the snooze apparatus 10. Likewise, although the display 22 is located on a side of the snooze apparatus 10, so that individuals will be able to see the amount time from a distance from the snooze apparatus, the display may be located anywhere on the housing 11 of the snooze apparatus 10.

In addition, a countdown timer may be provided on the housing 11 of the snooze apparatus 10 to display the amount remaining in the disruption period. For example, once the snooze button 14 is depressed, the countdown timer may display the amount of time remaining until the transmitting unit and receiving unit are placed back in communication by the snooze apparatus 10. Alternatively, the display 22 may start counting down as soon as the snooze button 14 is depressed. Thus, referring to FIG. 2, as soon as the snooze button 14 is depressed disrupting communication between the transmitting and receiving units, the display 22 may start to count down. Thus, once three minutes have passed after depression of the snooze button 14, the display 22 would read “17” as opposed to “20” as shown in FIG. 2. Once the display 22 reaches zero and the transmitting and receiving units are placed back in communication, the display 22 would show the number of minutes selected as the amount of the snooze time by the user (e.g. “20” in the present example). Alternatively, the display could also show the remaining snooze time in seconds or other suitable units.

In the event that the parent or caregiver would like to immediately resume monitoring the remote location before the snooze period has elapsed, another button (not shown) can be provided to immediately re-establish communication between the transmitting and receiving units. Likewise, if snooze button 14 is depressed, creating a period of disruption, communication may be immediately re-established. Thus, if the snooze button 14 is depressed, silencing the audio from the monitoring unit, the units may be placed immediately back into communication so that the individual can hear what sounds, if any, are being made at or near the transmitting unit by simply pushing the snooze button 14 again.

Advantageously, an individual, such as a parent, may quickly and easily re-establish communication in a period shorter than that selected by merely pushing the snooze button 14 or another button provided on the snooze apparatus 10. The individual may then monitor the remote location and decide whether to visit the remote location, continue listening to the receiving unit or adjust the time of disruption between the transmitting and receiving units prior to depressing the snooze button 14 again.

Although the term button is used herein, the buttons 14, 20, 24 do not need to be physically depressed. For example, heat or pressure sensitive mechanisms, dials, knobs, or other control devices may alternatively be used.

In another feature of the present invention, the snooze apparatus may advantageously be provided with noise level triggers which would bypass the snooze mechanism. For example, the volume at which a baby cries varies dramatically depending on the distress the baby is experiencing. Many babies increase the volume of their cries as the distress on the baby increases. Once many babies awake, they often whimper or cry at a relatively low volume for some time. After this low volume crying, the baby typically either falls back to sleep or increases the volume of his or her cries as the distress increases. The snooze apparatus 10 of the present invention may include a device (not shown) to register the decibel level of the sounds at or near the transmitting unit. In the event that the sound reaches a preset decibel level selected by the user, the snooze function may be overridden and place the transmitting and receiving units in immediate communication. For example, if a parent hears the baby making a low level of noise and decides to depress the snooze button 14, the snooze apparatus 10 may monitor the decibel level of the baby. If the baby becomes more distressed and cries louder, the decibels created by the baby will increase. Once the decibel level of the sounds made by the baby reaches a certain threshold pre-selected by the parent, the snooze function may be immediately over-ridden and the louder cries will be transmitted to the parent from the receiving unit.

Alternatively, the snooze apparatus 10 may be designed such that only sounds over a certain decibel level will be transmitted through the receiving unit. Thus, if a baby is making low volume noises such as gurgling, those noises will not be transmitted from the receiving unit and awaken the parent. Only when the sounds emanating from the baby reach a certain minimal threshold level would the snooze apparatus 10 permit the receiving unit to broadcast those sounds. In alternative embodiments, the volume of the sound transmitted through the monitor could be represented by one or more lights or LEDs while the audio signal is interrupted during the snooze period. Thus, a parent or caregiver can continue to monitor a volume level of a sound adjacent the transmitting unit even while the receiving unit is silent.

The snooze apparatus may also be designed to alert individuals when a sound reaches too low of a level at the location to be monitored. For example, many small or premature babies have not developed the skills necessary to breathe constantly. These babies sometimes stop breathing for short periods. In severe cases, this condition can lead to Sudden Infant Death Syndrome (SIDS). In order to prevent SIDS, doctors often recommend that small or premature babies be placed on a special mattress which blows air on the baby in a similar fashion to an air hockey table. The constant blowing of air is believed to prevent breathing disruptions and prevent SIDS. These air mattresses create a constant noise much like an air hockey table does. Thus, the snooze apparatus may be designed to sound an alarm in the event that the decibel level at the area to be monitored falls beneath the noise level generated by the air mattress. As a result, even if the snooze button 14 is depressed, if the air mattress malfunctions and the sound emanating from the area to be monitored falls to too low of a level during a period of disruption between the transmitting and receiving units, immediate communication can be reestablished and an alarm sounded alerting the parent of the malfunction of the air mattress.

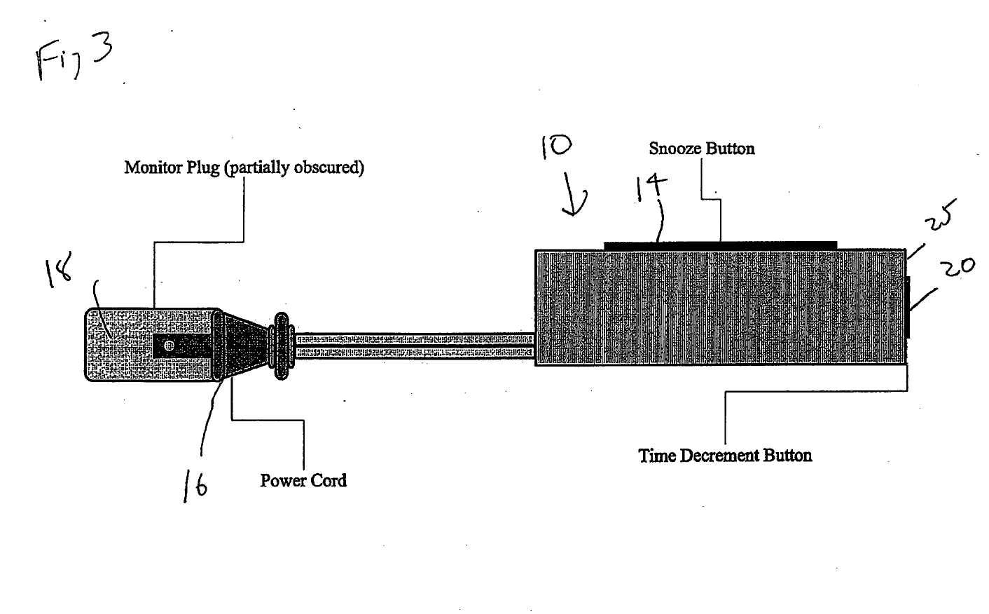

FIG. 3 illustrates a left side elevational view of the snooze apparatus of FIG. 1. Although the power cord 16 and monitoring plug 18 are shown as relatively short, it will be easily understood by those of skill in the art that the lengths of these cords may be of any length. The front surface 25 of the monitor 10 may be vertical as shown in FIG. 3, or can be sloped so that an individual whose eyes are located above the snooze apparatus 10 may easily see the display 22 (FIG. 2). The snooze apparatus 10 may be placed on any surface such as a night table next to a bed, a kitchen counter or any other desired location. Likewise, the snooze apparatus may be placed on its side without affecting the operation of the snooze apparatus 10.

Although the snooze apparatus 10 of FIGS. 1-3 is shown as a separate unit which may be placed in communication with standard monitors available in the marketplace, another preferred embodiment of the present invention would include the features of the snooze apparatus in the same housing as the receiving unit of the monitor, creating one unitary structure. Thus, a separate apparatus 10 would not need to be transported with the receiving unit of the monitor. This would be particularly useful for monitors which include receivers designed to be easily transportable.

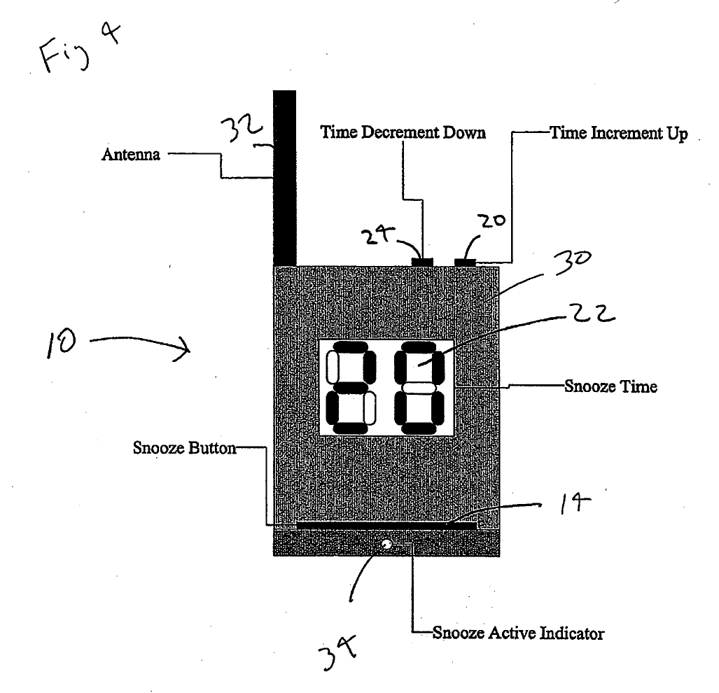

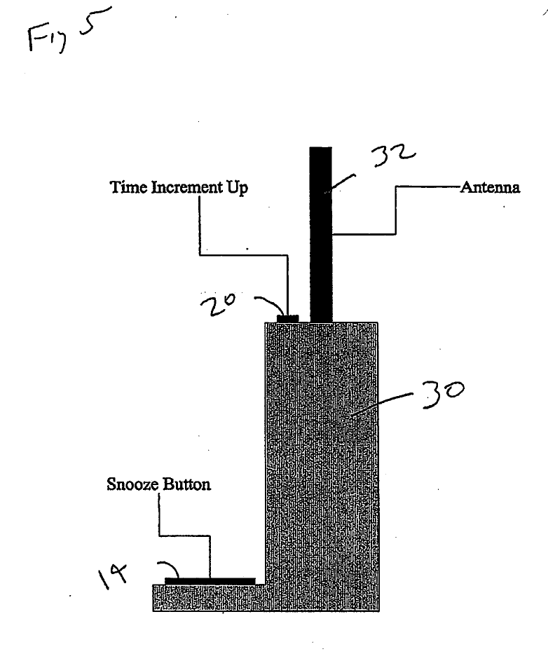

Another preferred embodiment of the snooze apparatus 10 is illustrated in FIGS. 4-6. A snooze apparatus 10 is provided with a housing 30 having an L-shape configuration (see FIG. 5). The snooze button 14 is, in a similar fashion to FIGS. 1-3, located on a horizontal surface of the snooze apparatus 10. Likewise, the time display 22 is located on a vertical surface of the housing 30 for easy viewing by an individual. Additional buttons 20, 24 are provided to change the amount of time set forth on the display 22. By pushing a first button 20, the amount of time on the display 22 is increased, while depressing the button 24, decreases the amount of time on the display 22. An antenna 32 is provided for communication with the receiving unit of the monitor if the snooze apparatus is separate from the receiving unit. Otherwise, if the snooze apparatus and receiving unit are unitary, the antenna would communicate with the transmitting unit. The function of the elements shown in FIGS. 4-6 is similar to the function of like elements shown in FIGS. 1-3 discussed above. In an alternate use of this embodiment, the snooze apparatus functions by communicating with a device (not shown) that is connected to the receiving unit of a standard monitor, such as by receiving the power cord of the receiving unit. That device would disrupt (or otherwise affect) the sound emanating from the receiving unit when the snooze button is depressed.

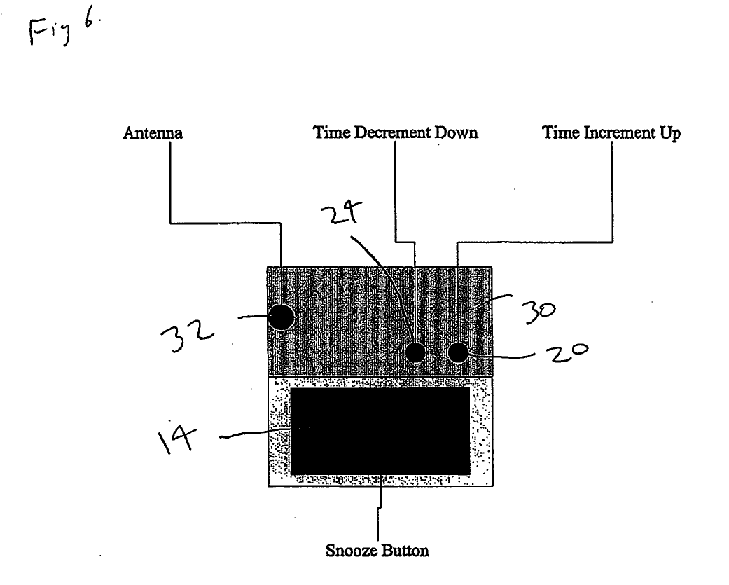

Referring to FIG. 4, a snooze active indicator light 34 is provided. Once the snooze button 14 is depressed, the light turns on indicating to the user that communication between the transmitting unit and receiving unit has been disrupted. Such an indicator light can also be provided on the embodiment of FIGS. 1-3. The light may be located elsewhere on the unit or in the display 22. FIGS. 5 and 6 illustrate right side elevational and top plan views of the snooze apparatus 10 of FIG. 4.

In another method of using the snooze apparatus of the present invention, in the event that the receiving unit is located near two parents or care providers, the snooze apparatus is useful in preventing disruption of one of the parents or care providers. For example, if two parents are sleeping and a baby at a remote location begins to cry, the transmitting unit transmits the sounds of the baby's cries to the receiving unit which broadcasts them to both parents. Oftentimes, only one parent will get up to tend to the baby. With the snooze apparatus described herein, that parent may press the snooze button 14 as he or she gets up to tend to the baby. Thus, the parent remaining in bed does not need to listen to or be disturbed by the continual cries of the baby until the baby is soothed by the parent attending to the baby. As a result, the parent not attending to the baby may sleep restfully, without having to listen to the baby crying for lengthy periods while the other parent soothes and cares for the baby at the remote location. Similarly, if two parents are watching television and a baby starts to cry, one parent may attend to the baby and the other can continue watching the television program without audible interference from the receiving unit of the monitor.

As will be understood by those of skill in the art, the monitor of the present invention may also allow for transmission of sounds or other forms of communication from the receiving unit to the transmitting unit. For example, the monitor may be provided with apparatus to permit the parent or care provider to transmit a live verbal message or a prerecorded message to the baby at the remote location. Thus, the monitors of the present invention may provide for two-way communication in addition to one-way communication from the transmitting unit to the receiving unit.

It is also contemplated by the present inventors that the snooze apparatus may be unitary with or adjacent to the transmitting unit in addition to or instead of with the receiving unit. For example, a parent caring for a baby may want to disrupt communication between the transmitting and receiving unit so as not to disturb people adjacent the receiving unit. If a parent attending to a baby is not able to stop the baby from crying, the parent may want to disrupt the communication for a short period of time by simply pressing a snooze button unitary with or adjacent to the transmitting unit so that the other parent or individuals adjacent the receiving unit do not need to hear the baby cry. Thus, the features of the present invention may be incorporated into or adjacent the transmitting unit, the receiving unit or both units.

Preferably, the transmitting and receiving units communicate by way of radio frequencies or other communication techniques known to those of skill in the art.

### SCOPE OF THE INVENTION

The above presents a description of the best mode contemplated of the monitor and manner of using the monitor, in such full, clear, concise and exact terms as to enable any person skilled in the art to which it pertains to make and use the monitor. The monitor is, however, susceptible to modifications and alternate constructions from that discussed above that are fully equivalent. Consequently, the monitor described above is not limited to the particular embodiments disclosed. On the contrary, the present invention covers all modifications and alternate constructions coming within the spirit and scope of the monitor as generally expressed by the following claims, which particularly point out and distinctly claim the subject matter of the present invention.

1. A snooze apparatus for temporarily silencing a receiving unit of a monitoring system, the apparatus comprising:
a device comprising a timer, an actuator and an interrupt circuit configured to interrupt a signal produced by the receiving unit when the actuator is engaged, wherein the signal is interrupted for no longer than a duration selected on said timer.

2. The apparatus of claim 1, wherein the device is separate from the receiving unit.

3. The apparatus of claim 1, wherein the signal is an audio signal.

4. The apparatus of claim 1, wherein the signal is a video signal.

5. The apparatus of claim 1, wherein the interrupt circuit is configured to interrupt a power supply to the receiving unit.

6. The apparatus of claim 1, wherein the interrupt circuit is configured to interrupt a signal communicated to a speaker of said receiving unit.

7. The apparatus of claim 1, wherein the interrupt circuit is configured to interrupt a communication signal between the receiving unit and a transmitting unit located adjacent a baby.

8. The apparatus of claim 1, wherein the system is configured to re-establish the audio signal once the timer expires.

9. The apparatus of claim 1, further comprising a second actuator configured to re-establish the audio signal before the timer expires.

10. The apparatus of claim 1, further comprising a decibel meter coupled to the system.

11. The apparatus of claim 10, wherein the decibel meter is configured to re-establish the audio signal prior to expiration of the timer when the decibel meter registers a sound exceeding a pre-selected decibel level.

12. The apparatus of claim 10, wherein the decibel meter is configured to re-establish the audio signal prior to expiration of the timer when a decibel level measured by the decibel meter falls below a pre-selected level.

13. The apparatus of claim 10, wherein the snooze apparatus comprises a visible display configured to indicate changes in a decibel level measured by the decibel meter.

14. The apparatus of claim 1, wherein the actuator is a button located on the snooze apparatus.

15. The apparatus of claim 1, wherein the timer comprises a digital display.

16. The apparatus of claim 1, further comprising an indicator light configured to be illuminated when the audio signal is interrupted.

17. A method comprising:
placing a transmitter unit of an audio monitor adjacent a person to be monitored;
placing a receiver unit of an audio monitor adjacent a caregiver;
providing the receiver unit with a snooze apparatus;
setting a timer of the snooze apparatus to a pre-selected interval;
upon hearing a sound through the monitor, depressing a snooze button of the snooze apparatus, wherein depressing the snooze button starts the timer and silences the receiver unit, and;
re-establishing the audio signal.

18. The method of claim 17, wherein the snooze apparatus is not integral with the receiver unit.

19. The method of claim 17, wherein re-establishing the audio signal occurs after the pre-selected time interval has elapsed.

20. The method of claim 17, wherein the receiver unit is silenced by interrupting an audio signal supplied to a speaker of the receiver unit.

21. The method of claim 17, wherein the receiver unit is silenced by interrupting a power signal supplied to the receiver unit.

22. The method of claim 17, wherein the receiver unit is silenced by interrupting a power signal supplied to the transmitter unit.

23. The method of claim 17, wherein re-establishing the audio signal occurs before the pre-selected time interval has elapsed.

24. The method of claim 17, further comprising selecting an acceptable decibel level.

25. The method of claim 24, wherein the audio signal is re-established when the selected decibel level is exceeded.

26. The method of claim 24, wherein the audio signal is re-established when the decibel level adjacent the transmitter unit falls below the selected decibel level.
